(19) United States
(12) Patent Application Publication
(10) Pub. No.: US 2018/0353009 A1
(43) Pub. Date: Dec. 13, 2018

(54) AN ADJUSTING DEVICE FOR ADJUSTING THE POSITION OF A GRILL RACK

(71) Applicant: Hendrik Francois KROMBERG, Faerie Glen (ZA)

(72) Inventor: Hendrik Francois KROMBERG, Faerie Glen (ZA)

(21) Appl. No.: 15/781,416

(22) PCT Filed: Dec. 2, 2016
(86) PCT No.: PCT/IB2016/057291

§ 371 Date: Jun. 4, 2018

(30) Foreign Application Priority Data
Dec. 4, 2015 (GB) 1521412.5

(51) Int. Cl. A47J 37/07

(52) U.S. Cl. CPC A47J 37/0786; A47J 2037/0795

(57) ABSTRACT

The invention discloses an adjusting device for adjusting the position of a grill rack relative to a combustible heat source. The device comprises an annular body defining at least one track in the form of a slot extending through the body partially around the circumference thereof; a support for supporting the grill rack being provided with an adjustment guide extending through the slot for travelling along the track; and at least one retaining formation for releasably retaining the adjustment guide in a position intermediate the two extremities of the track. Movement of the adjustment guide along the track moves the support and grill rack relative to the heat source. The device can be used with, or be integral with a kettle-type grill or be used as a barbeque grill on its own and is configured such that the components are collapsible and stackable for convenient storage and transportation.

### FIELD OF INVENTION

This invention relates to an adjusting device for adjusting the position of a grill rack relative to a combustible heat source for use as or with a barbeque grill.

### BACKGROUND OF INVENTION

The preparation or cooking of food, such as meat, can be achieved in various ways. One such a method, especially popular in countries where outdoor and recreational activities form an integral part of social interaction, is exposing the food to a combustible heat source derived from burning wood, coal or gas. This is often called a barbecue or grill.

These methods typically involve a grill rack suspended above the heat source located on or in a base, the grill rack forming a support on which the food is located. These components are collectively referred to as a barbeque grill.

In order to expose the food to a desired temperature, it is essential to manage the relative position between the grill rack and the heat source to control the effective heat transfer to the food. Controlling the effective heat transfer is essential as various foods require different temperatures at which it is to be cooked and various periods of exposure to the heat. In addition various heat sources, such as wood and coal fires effectively lose heat over time leading to the need for adjusting the grill rack relative to the heat source to maintain the desired heat transfer to the food. It is therefore essential for the height or position of the grill rack to be adjusted relative to the heat source.

A variety of methods for adjusting the height of the rack relative to the heat source is known in the art. These methods include amongst others, upright tracks with predetermined slots or holes for inserting holding members to keep the grill rack in place; and a plurality of horizontal channels or stepped members provided at different heights on which the grill rack can be positioned.

One of the disadvantages associated with these types of adjustable grill racks is that the adjusting members are usually in close proximity to the heat source, is subsequently often very hot and thus uncomfortable and even dangerous to operate. Where no adjusting members are provided, manipulation of the grill rack itself is required and is similarly dangerous to the user.

A further disadvantage of these grill racks are that they invariably require manipulation of the rack by both hands of a user.

Another disadvantage is that grill racks and heat source are often not enclosed, exposing the heat source to the elements and leading to substantial loss of heat. Exposed fires are furthermore dangerous to the user and environment, particularly in windy areas.

In barbeque grills with lids, such as kettle-type grills, a disadvantage is that the lids have to be removed before making adjustments to the height of the grill rack, exposing the heat source to the user and environment, and allowing heat to escape and the food to be exposed.

Grill racks of some barbeque grills are often not adjustable at all, making preparation of the food cumbersome.

It is also usually not possible to make use of a multitude of grill racks within the same grill and these grill racks are not independently adjustable.

FR2947163 teaches a device suitable for adjusting the position of a grill rack by manipulating a handle to move the grill rack along a track in an annular body integral with the barbeque grill. The construction of this invention is fairly complicated and accordingly cumbersome to manufacture, operate and clean. As it is integral with and located within the barbeque grill, and because it provides the user limited access thereto, any repair required is difficult. The construction of the mechanism furthermore provides limited functionality to the user. The construction of this mechanism furthermore necessitates moving a handle required to manipulate the height of the grill rack out of the plane of the grill rack which further complicates the adjusting mechanism.

### OBJECT OF THE INVENTION

It is accordingly an object of the present invention to provide a device for adjusting the position of a grill rack relative to a heat source for use as or with a barbeque grill with which the above disadvantages could at least partially be overcome or alleviated and/or to provide a more useful alternative to the known devices.

### SUMMARY OF INVENTION

According to a first aspect of the invention, there is provided an adjusting device for adjusting the position of a grill rack, extending in a plane relative to a combustible heat source, the adjusting device comprising:
an annular body in the form of a cylindrical tube, formed from a plurality of interconnected sheet metal segments to constitute the cylindrical tube, the arrangement being such that the segments, when not constituting the cylindrical tube, are stackable in planar arrangement, the annular body further defining at least one track in the form of a slot extending through the body partially around the circumference of the body;
a support for supporting the grill rack, the support being provided with an adjustment guide extending through the slot for travelling along the track;
at least one retaining formation for releasably retaining the adjustment guide in a position intermediate the two extremities of the track,
   the arrangement being such that movement of the adjustment guide along the track moves the support and grill rack relative to the heat source in a direction perpendicular to the plane.

The invention further provides for the retaining formation to be in the form of a step provided in the track.

Further according to the invention the track is a first track and the annular body defines two additional tracks, arranged equidistantly around the circumference of the annular body.

Preferably the second and third tracks are each also in the form of a slot extending through the body, with the support being provided with two additional adjustment guides, each for engaging the second or third track respectively.

Further according to the invention the adjusting device may further be provided with at least one handle disposed on the outside of the annular body and connected to at least one of the adjustment guides.

The annular body may include a pair of removable handles disposed on the operative outside thereof.

At least two of the sheet metal segments may be hingedly connected at end regions of the respective sheet metal segments. Each of the metal segments that are hingedly connected may comprise a sheet metal tab that is folded back to define an aperture at an end region of the sheet metal segment, and wherein the apertures of two respective sheet metal segments may be aligned and provided with a pin to define the hinge therebetween.

A retaining formation may be provided to limit the permissible extent of pivoting between the sheet metal segments that are hingedly connected. The retaining formation may be formed by a sheet metal section extending beyond the hinge of one of the sheet metal segments on the operatively inner side of the annular body.

The invention further provides for a first end, being an operatively bottom end of the annular body to be configured to engage an opening of the base of a kettle type grill and an operatively top end is configured to engage a lid of the kettle type grill.

The support may comprise at least two hingedly connected members extending horizontally within the annular body, the two members provided in the same plane as the handle connected to the adjustment guide. The members may extend between substantially opposite sides of the annular body to form a brace.

According to a second aspect of the invention there is provided a kettle-type grill, having a base and a removable lid provided with an adjusting device according to a first aspect of the invention disposed between the base and the lid.

According to a third aspect of the invention there is provided a barbeque grill comprising the adjustment grill according to the first aspect of the invention and a grill rack configured to locate on the support within the annular body.

### BRIEF DESCRIPTION OF DRAWINGS

The invention will now be described further by way of a non-limiting example, with reference to the accompanying drawings wherein:

FIG. 1 illustrates a perspective view of an adjusting device in accordance with a first embodiment of the invention;

FIG. 2 is a side view of the adjusting device of FIG. 1;

FIGS. 3 & 4 shows front perspective views of the adjusting device of FIG. 1 located on a kettle-type grill with the grill rack in two different respective positions;

FIG. 5 illustrates the adjustment device of FIG. 1 in a disassembled form;

FIG. 6 is a perspective view of an adjusting device in accordance with a second embodiment of the invention;

FIG. 7 is a detailed view of a hinge of the device of FIG. 6; and

FIG. 8 shows the adjusting device of FIG. 6 in various stages of disassembled form.

### DESCRIPTION OF A PREFERRED EMBODIMENT OF THE INVENTION

With reference to the drawings an adjusting device for adjusting the position of a grill rack, extending in a plane relative to a heat source according to the invention is generally designated by reference numeral 10.

The adjusting device 10 comprises an annular body 12 defining a track 14 in the form of a slot extending through the annular body 12 for slidably receiving the ends of a grill rack support 16, the ends of which terminate in adjustment guides 18 extending through the body 12. The track 14 furthermore comprises a retaining formation 20 for releasably retaining the support 16 in a plurality of positions intermediate two extremities of the track 14, such that movement of the adjusting guides 18 along the track 14 moves the support 16 relative to a heat source, disposed below or within the device 10, in a plane perpendicular to the plane of the heat source.

The annular body 12 is in the form of a cylindrical tube which is formed from a plurality of connected sheet metal segments. When not constituting the cylindrical tube, the sheet metal segments are stackable in planar arrangement as will be explained in more detail below. In the example embodiments described herein, the annular body 12 consists of three separate and individual interconnected sheet metal segments 12A, 12B and 12C.

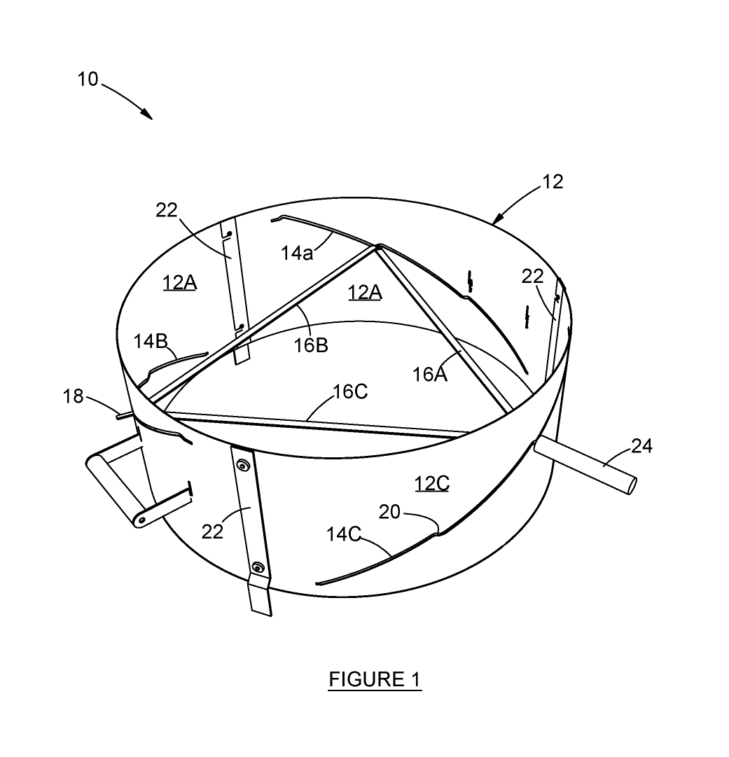

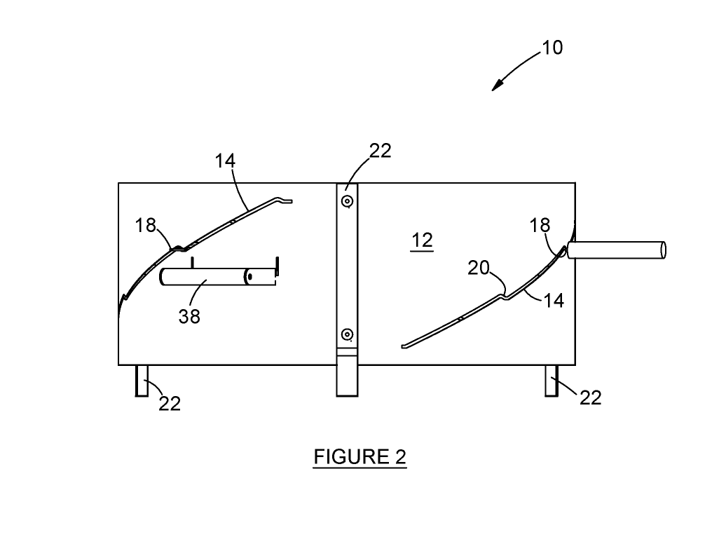

In a first example embodiment, as shown in FIGS. 1 to 5, the sheet metal segments are releasably secured to each other by suitable connection members 22 to form the annular body 12 as a substantially cylindrical tube.

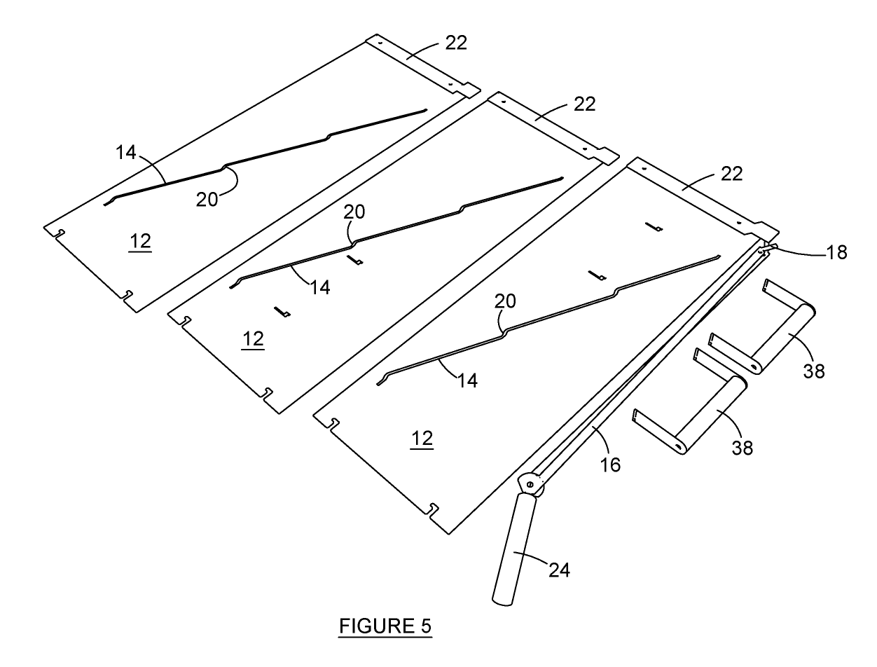

In a second example embodiment, as shown in FIGS. 6 to 8, the sheet metal segments are connected by means of a first and second hinge (40, 42), which are located at end regions of the respective sheet metal segments (12A, 12B and 12C). The first hinge 40 connects a first end region of the first sheet metal segment 12A to a first end region of the second sheet metal segment 12B. The second hinge 42, in turn connects a second end region of the second sheet metal segment 12B to a first end region of the third sheet metal segment 12C. Second ends of the first and third sheet metal segments (12A, 12C) are connected by suitable connection members 22 to form the substantially cylindrical tube.

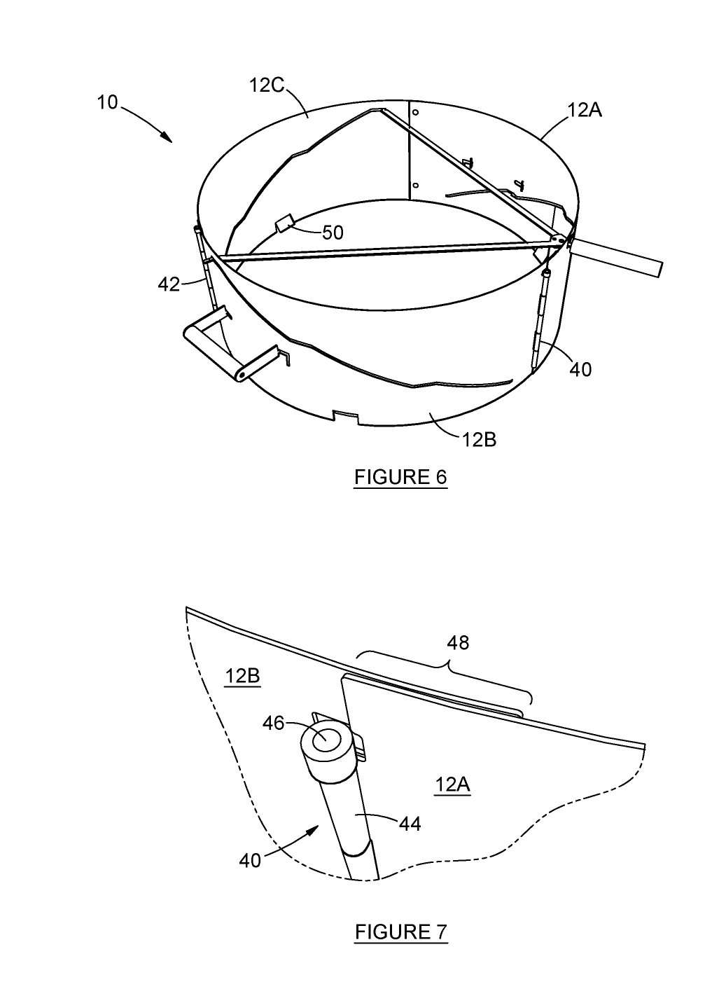

The first and second hinges (40, 42) are formed by folded-over sheet metal tabs 44 defining apertures, the tabs being integral to the respective sheet metal segments. The apertures of two adjacent sheet metal segments, such as 12A and 12B as shown in FIG. 7, are aligned and provided with a pin 46 to complete the hinge.

Each hinge is provided with a retaining formation 48 to limit the permissible extent of pivoting between the sheet metal segments (12A, 12 B and 12C) that are hingedly connected. The retaining formation 48 prevents the hinges from pivoting more than 180 degrees relative to each other. In practice, as soon two hingedly connected sheet metal segments are pivoted through 180 degrees, the hinges will lock. An attempt to pivot the respective sheet metal segments beyond 180 degrees will result in elastic deformation of the respective sheet metal segments, whereby the substantially cylindrical tube will be formed. This facilitates maintaining the shape of the annular body 12 in order for the device 10 to be positioned and maintained over a barbeque grill, such as a kettle grill, as explained below.

The retaining formation 48, as shown in the second embodiment, is formed by a sheet metal section extending beyond the hinge of the specific sheet metal segment, on the operatively inner side of the annular body 12. FIG. 7 shows the hinge formed between the first and second sheet metal segments (12A, 12B). In this instance, the sheet metal section of the second sheet metal segment 12B extends beyond the first hinge 40, and presses against the first sheet metal segment 12A as soon as the hinge pivots through 180 degrees.

Each of the sheet metal segments 12A, 12B and 12C is provided with a track 14 formed as a slot extending therethrough and which tracks 14A, 14B and 14C are equidistantly spaced apart and substantially identical.

The grill rack support 16 comprising three interconnected arms 16A, 16B and 16C is placed within the annular body 12, such that the three ends which are formed extend through the slot of the track 14 to terminate in adjustment guides 18, slidable in the track 14, as will be described in more detail below. It will be understood that two arms forming the support 16 may also be suitable in some applications.

One of the adjustment guides 18 is fitted with a handle 24 to facilitate manipulation of the support 16 during use. The handle 24 is manufactured from low thermal conductive material such as wood, to facilitate comfortable and safe handling thereof during use.

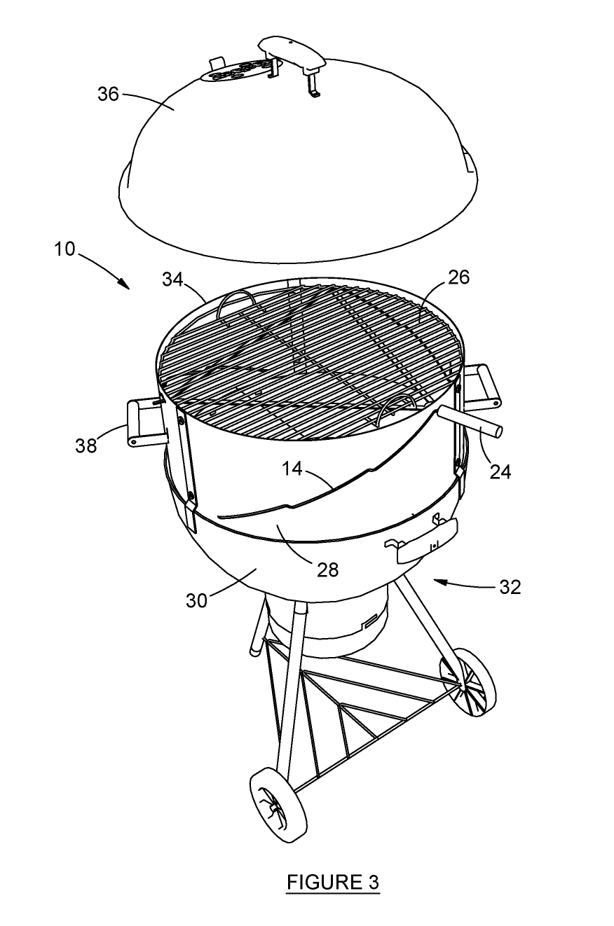

In use, the adjusting device 10 is placed over a heat source such as a flame created by a wood, coal or gas fire, or even an electrical element (not shown). As shown in FIGS. 3 and 4 a grill rack 26 is placed on the support 16. Food to be prepared or cooked (not shown) is placed on the grill rack 26. The arms 16A, 16B and 16C forms a brace on which the grill rack 26 is placed and provides sufficient strength and support for accommodating the food.

To manage and control the heat transfer to the food, the height of the grill rack 26 is adjustable relative to the heat source. The distance of the grill rack 26 from the heat source i.e. the height of the grill rack 26 is adjusted by manipulating the handle 24 to rotate the support 16 such that the adjustment guides 18 slide along the tracks 14 of the annular body 12. Resulting from the particular inclination of the first embodiment shown in FIGS. 1 to 5, manipulating the handle to the right side will cause the support 16 and grill rack 26 to move to a location spaced away from the heat source, whereas movement of the handle in the left direction will cause the support 16 and grill rack 26 to move closer to the operatively bottom end of the device 10, therefore nearer to the heat source. The inclination of the track in the second embodiment, shown in FIGS. 6 to 8, is opposite to that of the first embodiment, such that movement of the handle to the right, will cause movement of the grill rack nearer to the heat source.

The track 14 further defines a retaining formation 20 in the form of a step in the track 14 in which the adjustment guides 18, and therefore the support 16 rest, to releasably retain the grill rack 26 in various positions relative to the heat source. Examples of the different relative positions of the grill rack 26 are illustrated in FIGS. 3 and 4.

The grill rack 26 is accordingly at all times positioned within the annular body 12, which facilitates heat retention by shielding against outside elements, such as wind.

The annular body 12 is sized and configured such that a bottom end 28 thereof is engageable with the top, open end of the base 30 of a conventional kettle-type grill 32. In this respect, and according to the first example embodiment, the connecting members 22 are configured and extended as shown such that the device 10 is reasonably secured on the kettle-type grill 30. According to the second example embodiment, sheet metal tabs 50 extending toward an operatively inner side of the annular body are provided to engage the open end of the conventional kettle-type grill. The retaining formation on the second embodiment further facilitates positioning and maintaining the shape of the annular body relative to the kettle-type grill as mentioned above. A top end 34 of the annular body 12 is, in turn, sized to receive the lid 36 of the kettle-type grill 32. The proper

Since the adjustment guides 18 extend through the sheet metal segments 12A, 12B and 12C, and the handle 24 is located on the outside of the annular body 12, adjustment of the grill rack 26 is possible while the lid 36 is in place over the annular body 12. A user is also required to use only one hand, making adjustment of the grill rack 26 simple and convenient.

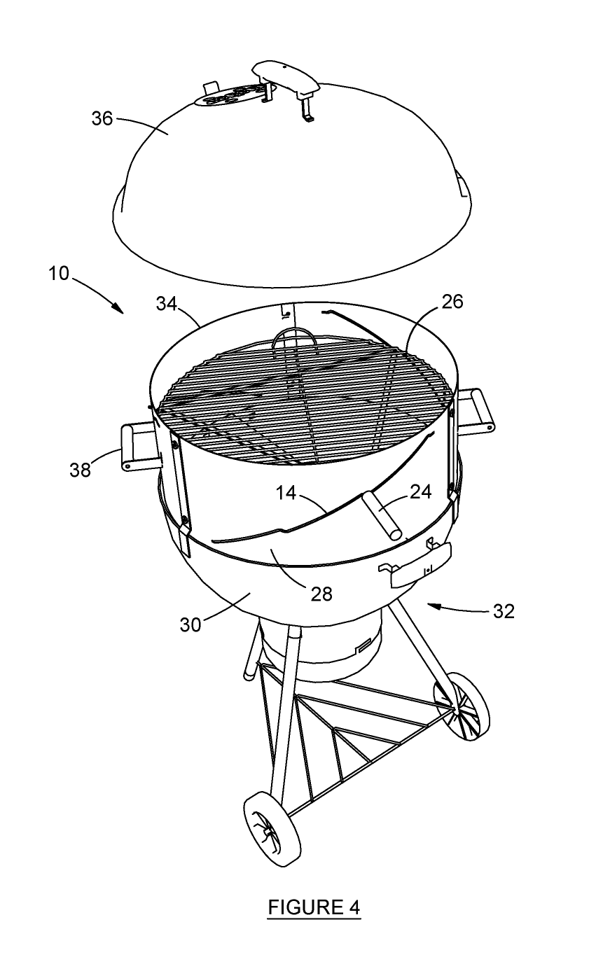

The adjustment guides 18 are furthermore smaller in size compared to the rest of the support 16 as is particularly evident from FIG. 5. This facilitates movement of the adjustment guides 18 along the track as resistance is minimised.

If rearrangement or adjustment of the heat source is required, the device 10 can simply be lifted from the kettle-type grill 32 using handles 38 located on sides of the annular body 12. During this operation, the food is retained on the grill rack 26, and the lid 36 can be left in position over the rack 26 thereby facilitating heat retention and avoiding outside exposure of the food.

The device 10 may alternatively be used on a flat surface such as the ground or pavement with the heat source located on the ground. In this instance, the device 10 forms a separate and independent barbeque grill and may be used without a kettle-type grill.

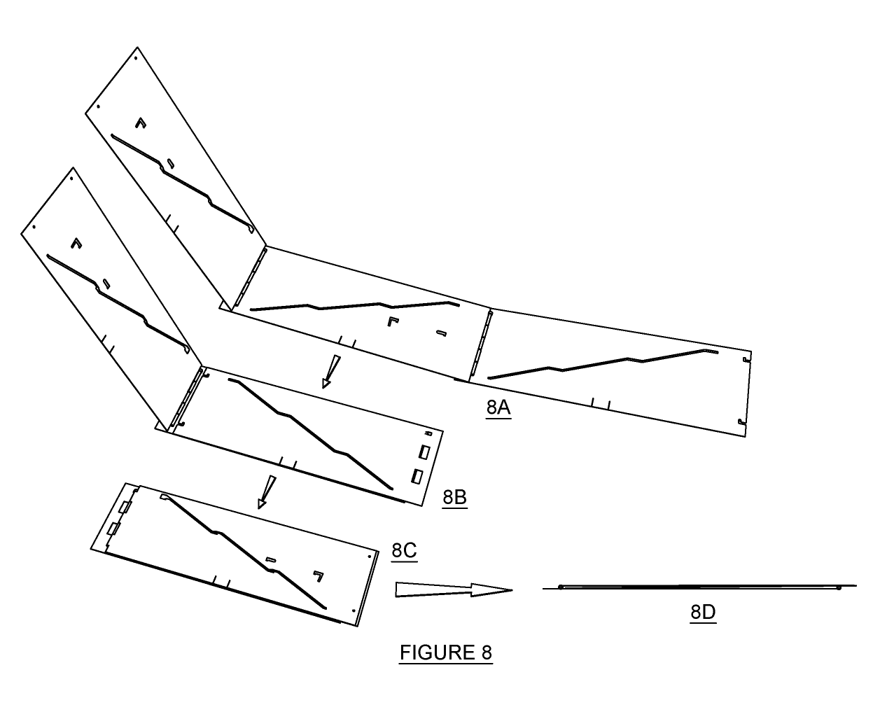

All components of the embodiment can be disassembled and collapsed as shown in FIGS. 5 and 8 and easily cleaned. The pivoting of the sheet metal segments of the second example embodiment facilitates stacking the sheet metal segments, as is shown in FIG. 8 with various stages (8A to 8C) of disassembling the segments wherein the segments are stacked in planar arrangement. The stacking of the second example embodiment provides the yet further advantage of the sheets configured to be a single stackable component, alleviating the risk of segments getting lost.

The sheet metal segments 12A, 12B and 12C can therefore easily be stored in a compact and relatively flat manner, making transportation and storage of the device convenient. The components can accordingly be provided in a convenient kit form.

It is accordingly asserted that the invention at least partially alleviates the aforementioned disadvantages.

Adjustment of the grill rack can be done by manipulating the handle from the outside of the device, thereby avoiding handling of hot components and can be done using only one hand. The invention further avoids exposure of the food to the outside during adjustment of the grill rack and operations to rearrange/adjust the heat source and furthermore provides shielding of the outside to facilitate heat retention proximate the food.

The device 10 is convenient for use during camping trips and recreational activities due to its ease of use, mobility and convenience of transportation. The device can furthermore be retrofitted onto existing kettle-type grills, or may be used as a barbeque grill on its own.

A significant advantage of the invention over the prior art is the portability, retrofittability and collapsibility of the device.

It will be appreciated by those skilled in the art that the invention is not limited to the precise details as described herein and that many variations are possible without departing from the scope and spirit of the invention. For example, the retaining formation can be replaced by a suitable locking mechanism such as clamps or pins (not shown) or any other suitable formation which can retain the support in the various positions along the track.

The description is presented in the cause of providing what is believed to be the most useful and readily understandable description of the principles and conceptual aspects of the invention. In this regard, no attempt is made to show structural details of the invention in more detail than is necessary for a fundamental understanding of the invention. The words used here should be interpreted as words of description rather than words of limitation.

1. An adjusting device for adjusting the position of a grill rack, extending in a plane relative to a combustible heat source, the adjusting device comprising:
an annular body in the form of a cylindrical tube, formed from a plurality of sheet metal segments that are connected to one another to constitute the cylindrical tube, the arrangement being such that the segments, when not constituting the cylindrical tube, are stackable in a planar arrangement, the annular body further defining at least one track in the form of a slot extending through the body partially around the circumference of the body;
a support for supporting the grill rack, the support being provided with an adjustment guide extending through the slot for travelling along the track;
at least one retaining formation for releasably retaining the adjustment guide in a position intermediate the two extremities of the track,
the arrangement being such that movement of the adjustment guide along the track moves the support and grill rack relative to the heat source in a direction perpendicular to the plane.

2. An adjusting device according to claim 1, wherein the retaining formation is in the form of a step provided in the track.

3. An adjusting device according to claim 1, wherein the track is a first track and the annular body defines two additional tracks arranged equidistantly around the circumference of the annular body.

4. An adjusting device according to claim 3, wherein the second and third tracks are also in the form of a slot extending through the body, with the support being provided with two additional adjustment guides, each for engaging the second or third track respectively.

5. An adjusting device according to claim 1, wherein the adjusting device is provided with at least one handle disposed on the outside of the annular body and connected to at least one of the adjustment guides.

6. An adjusting device according to claim 1, wherein the annular body includes a pair of removable handles disposed on the operative outside thereof.

7. An adjusting device according to claim 1, wherein at least two of the sheet metal segments are hingedly connected at end regions of the respective sheet metal segments.

8. An adjusting device according to claim 7, wherein each metal segment that is hingedly connected to another comprises a sheet metal tab that is folded back to define an aperture at an end region of the sheet metal segment, and wherein the apertures of two respective sheet metal segments are aligned and provided with a pin to define the hinge therebetween.

9. An adjusting device according to claim 7, wherein a retaining formation is provided to limit the permissible extent of pivoting between the sheet metal segments that are hingedly connected.

10. An adjusting device according to claim 9, wherein the retaining formation is formed by a sheet metal section extending beyond the hinge of one of the sheet metal segments on the operatively inner side of the annular body.

11. An adjusting device according to claim 1, wherein an operatively bottom end of the annular body is configured to engage an opening of the base of a kettle type grill and an operatively top end is configured to engage a lid of the kettle type grill.

12. An adjusting device according to claim 5, wherein the support comprises at least two hindgedly connected members extending horizontally within the annular body, the two members provided in the same plane as the handle connected to the adjustment guide.

13. An adjusting device according to claim 12, wherein the members extend between substantially opposite sides of the annular body to form a brace.

14. A kettle-type grill, having a base and a removable lid provided with an adjusting device according to claim 1, disposed between the base and the lid.

15. A barbeque grill comprising an adjustment device as claimed in claim 1 and a grill rack configured to locate on the support within the annular body.

16. An adjusting device according to claim 1, substantially as herein described with reference to the accompanying figures.

17. A kettle-type grill according to claim 14, substantially as herein described with reference to the accompanying figures.

18. A barbeque grill according to claim 15, substantially as herein described with reference to the accompanying figures.
